(19) United States
(12) Patent Application Publication
(10) Pub. No.: US 2016/0237362 A1
(43) Pub. Date: Aug. 18, 2016

(54) METHANOL FUELS FOR INTERNAL COMBUSTION ENGINES

(71) Applicant: UNIVERSITY OF SOUTHERN CALIFORNIA, Los Angeles, CA (US)

(72) Inventors: George A. OLAH, Los Angeles, CA (US); G.K. Surya PRAKASH, Hacienda Heights, CA (US)

(21) Appl. No.: 15/045,995

(22) Filed: Feb. 17, 2016

Related U.S. Application Data
(60) Provisional application No. 62/117,707, filed on Feb. 18, 2015.

(51) Int. Cl. C10L 3/00; F02B 43/10

(52) U.S. Cl. CPC C10L 3/00; F02B 43/10; C10L 2270/023; C10L 2270/026; C10L 2270/04

(57) ABSTRACT

The common interchangeable use of a high methanol content fuel for use in all types of internal combustion engines, including cars, trucks, vehicles for transportation use (ships, boats, locomotives, airplanes, etc.), various other equipment and turbines. The engines are converted to be able to use these fuels although further vehicles can be made with components that would allow such fuels to be used. These methanol fuels are renewable and environmentally benign when produced from carbon dioxide capture and recycling of their combustion or other use.

This application claims the benefit of U.S. provisional patent application No. 62/117,707 filed on Feb. 18, 2015, the entire content of which is expressly incorporated herein by reference thereto.

### BACKGROUND

An internal combustion engine (ICE) is an engine that operates by burning its fuel inside the engine. The most common ICE is gasoline powered, but others include those fueled by diesel, hydrogen, methane, propane, or other fuels. Typically, ICEs only run on one type of fuel and require adaptations to adjust the air/fuel ratio or mix to use other fuels. In a gasoline engine, for example, a mixture of gasoline and air is sprayed into a cylinder. This is compressed by a piston and at optimal point in the compression stroke, a spark plug creates an electrical spark that ignites the fuel. The combustion of the fuel results in the generation of heat, and the hot gases that are in the cylinder are then at a higher pressure than the fuel-air mixture and thus drive the piston back. The combustion gases are vented and the fuel-air mixture reintroduced to run a second stroke of the engine. The outward linear motion of the piston is ordinarily harnessed by a crankshaft to produce circular motion. Valves control the intake of air-fuel mixture and allow exhaust gasses to exit at the appropriate times. In a diesel engine, the diesel fuel and air is compressed to a degree that auto-ignition takes place.

In the 20th century, ICEs have become an essential part of our increasingly technological society and in general of our everyday life. In the transportation field, the pioneering work of Benz in Germany and Ford in the US made the widespread use of automobiles possible using gasoline fueled ICEs and became an essential part of our life. ICEs also found use in many other applications. These engines typically use fossil sources derived fuels, primarily originating from petroleum oil.

In addition to the common gasoline engines, diesel engines represent worldwide a significant part of all ICEs for cars, trucks, transportation equipment (e.g., ships, locomotives, etc.) as well as other vehicles and equipment. In contrast to gasoline engines, diesel engines run on heavier fossil fuel derived hydrocarbon mixtures, and thus represent a significant environmental pollution problem as their combustion causes excessive emission of harmful nitrogen oxide, sulfur-oxide and other exhausts as well as particulate pollutants.

The combined use of gasoline and diesel fuel represent an overwhelming dependence (some call it an addiction) on petroleum oil. Oil being a carbon fuel, upon its combustion (oxidative conversions) is used up irreversibly while emitting environmentally harmful carbon dioxide. Our oil reserves although significant are limited and we are increasingly depleting them. Oil prices in the last half-century have risen from $2 to around $30-100 USD per barrel representing a 15-50 fold increase! This occurred despite continuously finding new sources, savings and improved technologies. Prices fluctuate up and down with periodic steep drops and rises, but the increasing trend is clear. Thus, the need for alternate fuels is growing.

In an effort to reduce the pollution generated by diesel engines, certain biodiesel fuels have been developed. These fuels are typically mixtures of diesel fuel with biofuels (primarily bioethanol) and are used on a relatively small scale worldwide in a significant number of automobiles and varied heavy vehicles, ships, locomotives, etc. as well as in electricity generating turbines, emergency generators and varied other devices that use diesel oil. While these fuels do decrease some of the pollutants that are otherwise generated, they are not considered on their own to be able to affect a significant overall change in the demand for the relatively larger proportion of petroleum based components of such fuels.

There also exist certain fuels that contain some amounts of methanol generally at lower levels or in combination with other fuel components such as gasoline or ethanol or other alcohols. In some embodiments, the methanol content may be as high as 85%, but engine knocking and other problems have been identified at such high levels. Examples of such fuels include U.S. Pat. No. 4,398,920, U.S. Pat. No. 4,384,872, U.S. Pat. No. 8,353,269, U.S. Pat. No. 2009/0172997 and U.S. 2011/0120569, among others.

The present inventors have previously developed a much needed new chemistry for the technological applications of methanol to replace fossil fuels, (primarily petroleum oil) in many of their applications through what is called the “methanol economy” (see, e.g., U.S. Pat. No. 7,605,293 and U.S. Pat. No. 8,697,759). More recently the development by MIT and others of modified diesel engines (now called by MIT methanol engines) has started to gain practical use. Thus, there is a need for methanol based fuels for use in such vehicles.

In addition, it would be highly desirable to have a methanol based fuel that can be used as a substitute for both diesel as well as gasoline fuels in other vehicles in order to take advantage of the current infrastructure for distribution of such fuels on a larger scale that would reduce cost and provide distribution in a more economic and universal manner.

### SUMMARY OF THE INVENTION

The present invention now provides a new fuel that resolves the problems of the prior art by providing a renewable, clean and economic high methanol content fuel which can be universally used for all internal combustion engines. The new fuel can also be used in new and existing gasoline and diesel engines with certain minor modifications. In addition to reducing the reliance upon petroleum oil and the resultant pollution that is generated by combustion of such fuels, the universal use of these new fuels will be cost stable with less variances over time.

### DETAILED DESCRIPTION

The present invention in particular now discloses a method for providing methanol as a convenient universal common fuel for all types of internal combustion engines to replace fossil based fuels by gradually providing or converting such engines to operate solely on very high methanol content fuels or on neat methanol. The methanol content of these fuels is preferably above 85% with the remaining primary components of the fuel including gasoline, diesel fuel, ethanol or mixtures thereof. To be able to use such fuels, the engines are provided or modified to contain methanol resistant fuel delivery components in order to avoid corrosion from the high methanol fuels during operation and use.

The method further comprises modifying existing gasoline and diesel fuel infrastructure to be based only upon the production, distribution and sale of only the high methanol fuel. The modified or provided engines that can utilize the new fuels will be found in vehicles, such as cars, trucks, or heavy construction equipment, as well as in locomotives, ships, airplanes, electricity generators or turbines.

Preferably, the methanol is renewably generated by recycling carbon dioxide from combustion of carbon containing fuels or other materials. The combustion of the carbon containing fuels or other materials is typically conducted at a static, large scale operation to provide sufficient carbon dioxide to economically form methanol. In particular, the carbon dioxide is captured and stored as a future reactant to product methanol, e.g., by a hydrogenative conversion of carbon dioxide or through a bireforming process as disclosed in U.S. Pat. No. 8,697,759.

The invention also relates to the use of very high methanol content fuels or neat methanol as a convenient universal common fuel for all types of internal combustion engines replacing fossil based fuels wherein such engines are provided or modified to operate solely on such fuels.

Thus, the present invention discloses the concept of using methanol as a single common fuel for all types of ICE engines with great technological and economic advantages. Methanol is produced presently from natural gas or coal based syn-gas but can also be made from of carbon dioxide, wastes and cellulosic materials (wood chips, etc) or other natural sources. Methanol was originally called wood alcohol, as it was made by heating woodchips. In contrast to bioethanol (made from fermenting corn, sugar cane, etc.) biomethanol does not interfere with crops or related products for the food chain and thus does not cause price increases or economic difficulties in the production, distribution or sale of foodstuffs derived from such crops or related products.

The use of methanol in the scope of the “methanol economy” is increasing worldwide particularly for use in gasoline engines. Methanol is currently known as an alternative fuel for internal combustion and other engines, either in combination with gasoline or directly (“neat”) and is used in racing cars in certain countries. In the U.S., methanol fuel has received less attention than ethanol fuel as an alternative to petroleum-based fuels, because ethanol is less toxic and has higher energy density. The present invention recognizes and uses to advantage the fact that methanol is less expensive to produce sustainably and is used in a manner to reduce the carbon footprint of the world.

In order to optimize current engine performance, fuel availability, toxicity and political advantage, a blend of ethanol, methanol and petroleum may be preferable at the current time compared to the use of any of these individual substances alone, but over time a conversion to complete or nearly complete methanol would be expected due to the advantages of methanol based on costs, stability of resources for production and renewable nature while also reducing carbon dioxide generation. As noted, methanol may be made from hydrocarbon or renewable resources, in particular natural gas and biomass respectively, or more importantly, it is synthesized from carbon dioxide that is generated by the use of any combusted hydrocarbon fuels or other hydrocarbon based products or materials.

The recent development of modified spark assisted diesel engines by MIT and others for varied applications including development of maritime engines in Sweden and engines for electric power generating turbines in Israel represent the beginning commercialization of a new generation of modified more efficient methanol engines. These engines are to be used for varied applications in passenger cars, ships, barges and other transportation vehicles, airplanes electricity generators, etc. and in general replacing in all applications of diesel engines and turbines.

The present invention discloses the significant concept and general common use of methanol in all types of ICEs thus eventually eliminating the needed dual infrastructure for use of gasoline and diesel oil, their separate production as well as storage, transportation and dispensation. In addition, methanol fuels can be rendered renewable by overall carbon dioxide capture and recycling at sources of major emission and larger static installations (i.e., at power plants or other large installations that run methanol fuels along with or instead of petroleum oils as disclosed in U.S. 2011/0086928). Methanol is thus an environmentally clean, economic and broad range fuel that is now to be universally used as disclosed herein.

Methanol is already proven as an excellent transportation fuel and is extending its use to all types of ICE engines as a common fuel used in millions of cars around the world. A methanol derived derivative, gaseous dimethyl ether (DME), can also replace not only diesel fuel as a high cetane substitute but also as a substitute for heating oil as well as LPG (as household gas, as already proven in different countries such as China, Japan, etc).

The presently used methanol fuels once combusted irreversibly form carbon dioxide, a major greenhouse gas. In order to make methanol overall renewable and environmentally benign, carbon dioxide is captured and recycled by catalytic hydrogenation of carbon dioxide or by bireforming (see U.S. Pat. No. 8,697,759) with methane (natural gas) at major production or user facilities. Gasoline and diesel engines until now necessitate fundamentally different fuels, as well as production and infrastructure making necessary separate expensive production, storage and distribution facilities.

### EXAMPLES

For use of oil-based fuels (gasoline, diesel oil) in gasoline and diesel engines separate refinery production and infrastructure for distribution is needed. According to the present invention, methanol, a readily and economically produced and distributed common single fuel can be used in all types of internal combustion engines. The amount of methanol in mixed fuels initially will be in the lower range of 5% to possibly as much as 85%, but as vehicles and other engines are converted the methanol content will increase to above 85% to as high as 100% (i.e., neat methanol). Regular ICE engine cars have been are produced for a decade with oxygen sensors, which adjust the needed air for combustion of the fuel. The needed engine modification involves use of methanol resistant plastic tubing and connectors costing 200-300 USD per car. Fuels for modified methanol engines can run with methanol contents that are above 85% to as high as neat methanol. And while existing engines will need to be converted, future engines can be made with components that would allow such fuels to be used so that conversions or modifications of the engines are not necessary.

For methanol engines propelling heavy trucks and machinery, ships, locomotives, airplanes, electrical generators and also passenger cars renewable clean methanol fuel is advantageously used but the concept is applicable to any fossil derived methanol fuel. The present application discloses the use of methanol as a common single fuel essentially replacing fossil fuel based gasoline and diesel fuels for all types of internal combustion engines and turbines.

Needed alterations are readily made for older vehicles. The use of methanol as a convenient alternative fuel for all types of internal combustion engines can be readily introduced with a single infrastructure at a modest cost with obvious advantages.

In summary, the present invention allows the general common use of a single methanol fuel in an economic and environmentally benign way for all types of internal combustion engines, while decreasing our dependence on petroleum oil.

What is claimed is:

1. A method for providing methanol as a convenient universal common fuel for all types of internal combustion engines which comprises replacing fossil based fuels by gradually providing or converting such engines to operate solely on very high methanol content fuels or on neat methanol.

2. The method of claim 1 wherein the methanol content of the fuel is above 85%.

3. The method of claim 2 wherein the remaining primary components of the fuel include gasoline, diesel fuel, ethanol or mixtures thereof.

4. The method of claim 1 wherein the engines are provided or modified to contain methanol resistant fuel delivery components in order to avoid corrosion from the high methanol fuels during operation and use of the engines.

5. The method of claim 1 which further comprises modifying existing gasoline and diesel fuel infrastructure to be based only upon the production, distribution and sale of only the high methanol fuel.

6. The method of claim 1 wherein the engines are present in cars, trucks, construction equipment, locomotives, ships, electricity generators or turbines.

7. The method of claim 1 wherein the methanol is renewably generated by recycling carbon dioxide from combustion of carbon containing fuels or other materials.

8. The method of claim 7 wherein the combustion of the carbon containing fuels or other materials is conducted at a static, large scale operation to provide sufficient carbon dioxide to economically form methanol.

9. The method of claim 7 wherein the carbon dioxide is captured and stored as a future reactant to produce methanol by hydrogenative conversion or through a bireforming process.

10. Use of very high methanol content fuels or neat methanol as a convenient universal common fuel for all types of internal combustion engines and turbines replacing fossil based fuels wherein such engines are provided or modified to operate solely on such fuels.
